(19) United States
(12) Patent Application Publication
(10) Pub. No.: US 2016/0107490 A1
(43) Pub. Date: Apr. 21, 2016

(54) TIRE HAVING EMBEDDED ELECTRONIC DEVICE AFFIXED WITH ADHESIVE

(71) Applicant: Bridgestone Americas Tire Operations, LLC, Nashville, TN (US)

(72) Inventors: Amy M. Randall, Akron, OH (US); Paul B. Wilson, Tallmadge, OH (US); Terence E. Wei, Copley, OH (US); William J. Corsaut, Uniontown, OH (US)

(21) Appl. No.: 14/872,311

(22) Filed: Oct. 1, 2015

Related U.S. Application Data
(60) Provisional application No. 62/064,799, filed on Oct. 16, 2014.

(51) Int. Cl. B60C 19/00; B29D 30/50; B29D 30/00; B60C 15/06; B60C 15/00

(52) U.S. Cl. CPC B60C 19/00; B60C 15/0603; B60C 15/06; B60C 15/0635; B60C 15/0009; B29D 30/0061; B29D 30/50; B29D 2030/0077

(57) ABSTRACT

A tire includes a circumferential tread, a pair of sidewalls, and a pair of bead portions. Each bead portion includes a bead and a bead filler. The tire further includes at least one body ply extending from bead portion to bead portion. The body ply includes a pair of turn up portions radially outside of a respective bead portion. An electronic device is embedded in the tire. The electronic device is encapsulated in a curable adhesive including at least one of natural rubber, styrene butadiene rubber, and butadiene rubber.

### FIELD OF INVENTION

The present disclosure relates to the field of incorporating an electronic device in a tire. More specifically, the present disclosure relates to the field of embedding a radio frequency identification (“RFID”) tag in a tire with an adhesive.

### BACKGROUND

Incorporation of an electronic device, such as an RFID tag, into a tire can occur during tire construction and before vulcanization or in a post-cure procedure. Such electronic devices have utility in transmitting data, such as tire-specific identification data, to an external reader. Ultra-high frequency (“UHF”) tags are typically small and utilize flexible antennas for the transmission of data. During the manufacturing process, electronic devices may shift position or fall off of the tire. Additionally, air bubbles may form around the electronic device during vulcanization.

### SUMMARY OF THE INVENTION

In one embodiment, a tire includes an inner liner, a circumferential tread, and a pair of sidewalls. Each sidewall includes an outer rubber layer and a pair of bead portions. Each bead portion includes a bead and a bead filler having an apex. The tire further includes at least one body ply extending from bead to bead. At least a portion of the body ply is disposed between the inner liner and the outer rubber layer of each sidewall. The body ply includes a pair of turn up portions, each turn up portion having a turn up end axially outside of a respective bead and radially below the apex of a respective bead filler. The tire further includes an electronic device disposed between the inner liner and the outer rubber layer of one of the pair of sidewalls. The electronic device has an adhesive disposed thereon. The adhesive is one of a solvent-based adhesive and a water-based adhesive. The adhesive includes at least one of natural rubber, styrene butadiene rubber, and butadiene rubber.

In another embodiment, a tire includes a circumferential tread, a pair of sidewalls, and a pair of bead portions. Each bead portion includes a bead and a bead filler. The tire further includes at least one body ply extending from bead portion to bead portion. The body ply includes a pair of turn up portions radially outside of a respective bead portion. An electronic device is embedded in the tire. The electronic device is encapsulated in a curable adhesive including at least one of natural rubber, styrene butadiene rubber, and butadiene rubber.

In yet another embodiment, a method of embedding an electronic device in a tire includes forming a tire carcass by providing a pair of bead portions and a body ply. Each bead portion including a bead and a bead filler. The forming of the tire carcass further includes wrapping a portion of the body ply around each of the pair of bead portions. The method further includes providing an electronic device and encapsulating the electronic device with an adhesive selected from the group consisting of a solvent-based adhesive and a water-based adhesive. The adhesive includes at least one of natural rubber, styrene butadiene rubber, and butadiene rubber. The method also includes affixing the electronic device to the tire carcass, forming a green tire by providing sidewall compound and a tread compound on the tire carcass, and curing the green tire.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a cross section of an exemplary embodiment of a tire having an electronic device embedded therein; and

FIG. 2 is a schematic drawing of one embodiment of an electronic device.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Bead” refers to the part of the tire that contacts the wheel and defines a boundary of the sidewall.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Sidewall” refers to that portion of the tire between the tread and the bead.

“Tread” refers to that portion of the tire that comes into contact with the road under normal inflation and load.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

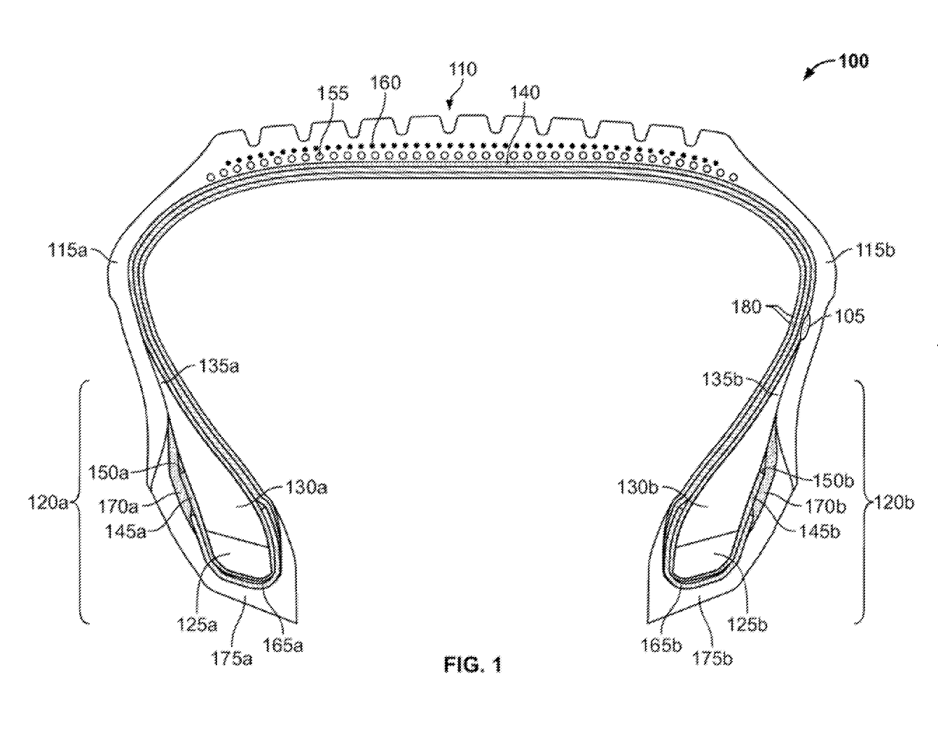

FIG. 1 illustrates a cross section of an exemplary tire 100 having an electronic device 105 embedded therein. In the illustrated embodiment, the tire 100 includes a circumferential tread formed of tread compound 110 and a pair of sidewalls formed of sidewall compound 115. In one embodiment, the tread compound 110 is substantially the same as the sidewall compound 115. In an alternative embodiment, the tread compound and the sidewall compound are different.

The pair of sidewalls includes a first sidewall formed of a first sidewall compound 115a and a second sidewall formed of a second sidewall compound 115b. In one embodiment, the first sidewall compound 115a is the same as the second sidewall compound 115b. The first sidewall compound 115a extends from a first bead region 120a to the tread compound 110. The second sidewall compound 115b likewise extends from a second bead region 120b to the tread compound 110. Each bead region includes a bead 125a,b and a bead filler 130a,b having an apex 135a,b. In an alternative embodiment (not shown), the bead filler does not have an apex.

The tire 100 further includes a body ply 140 extending from the first bead region 120a to the second bead region 120b. While only a single body ply 140 is shown in the illustrated embodiment, it should be understood that two or more body plies may be employed.

The body ply 140 wraps around each of the beads 125a,b, thereby forming a first turn up portion 145a and a second turn up portion 145b. The first turn up portion 145a terminates at a first turn up end 150a located axially outside of the first bead filler 130a and radially below the apex 135a of the first bead filler 130a Likewise, the second turn up portion 145b terminates at a second turn up end 150b located axially outside of the second bead filler 130b and radially below the apex 135b of the second bead filler 130a. In an alternative embodiment (not shown), each turn up portion terminates above the apex of the respective bead filler. In one specific embodiment, the turn up portion terminates in a crown region of the tire.

In the illustrated embodiment, the tire 100 further includes a belt 155 and a cap ply 160. In an alternative embodiment (not shown), the tire may include two or more belts. In another alternative embodiment (not shown), the tire may include two or more cap plies. In yet another alternative embodiment (not shown), the cap ply may be omitted.

In the illustrated embodiment, the tire 100 further includes a first wire reinforcement 165a in the first bead region 120a and a second wire reinforcement 165b in the second bead region 120b. Each wire reinforcement 165a,b wraps around the respective bead 125a,b and part of the respective bead filler 130a,b and body ply 140. The wire reinforcements 165a,b may provide a structural reinforcement to the tire 100, or it may protect the body ply 140 from abrasion. However, it should be understood that the wire reinforcements 165a,b need not serve such functions. In an alternative embodiment (not shown), the wire reinforcement may be omitted.

The tire 100 also includes a pair of reinforcement fillers 170, including a first reinforcement filler 170a located axially outside of the first bead filler 130a and a second reinforcement filler 170b located axially outside of the second bead filler 130b. In an alternative embodiment (not shown), the reinforcement filler is omitted.

The tire 100 further includes a pair of abrasion portions 175, including a first abrasion portion 175a and a second abrasion portion 175b. Each abrasion portion 175 at least partially wraps around a bead 125 and bead filler 130 such that each abrasion portion includes a first portion disposed axially outside a respective bead filler 130, reinforcement filler 170, and turn up portion 145 of the body ply 140. Each abrasion portion 175 further includes a second portion disposed below a respective bead 125. In an alternative embodiment (not shown), the abrasion portion is omitted, and the sidewall compound 115 extends into the bead region 120 and around the bead 125.

In the illustrated embodiment, a pair of inner liners 180 extends along the interior of the tire from the first bead region 120a to the second bead region 120b. One or both of the inner liners 180 is constructed of a material having low permeability, such that the inner liner 180 contains pressurized air within the tire cavity. In an alternative embodiment (not shown), a single inner liner is employed. In another alternative embodiment (not shown) the inner liners are omitted.

The electronic device 105 is embedded in the tire 100. In other words, the electronic device 105 is disposed between the inner liner 180 and the sidewall compound 115, such that it is not visible on the exterior of the tire or on the interior of the tire. In the illustrated embodiment, the electronic device 105 is disposed in the second sidewall region 115b at a location radially above the apex 135b of the second bead filler 130b and axially outside the body ply 140. The electronic device 105 is shown as sandwiched between the main portion of the body ply 140 and the second sidewall compound 115b. However, it should be understood that the electronic device may be disposed between any two layers of the tire. For example, in one embodiment (not shown) the electronic device may be sandwiched between an inner liner and a body ply. In an alternative embodiment (not shown), the electronic device may be sandwiched between a reinforcement filler and an abrasion portion. In another alternative embodiment (not shown), the electronic device may be sandwiched between a body ply and a bead filler. In yet another alternative embodiment (not shown) the electronic device may be sandwiched between two body plies. In still another alternative embodiment (not shown), the electronic device may be sandwiched between a bead filler and sidewall rubber. The above described embodiments should not be taken as limiting, as the electronic device may be embedded at any location on the tire.

While the illustrated embodiment shows the electronic device 105 disposed on the right side of the tire 100, it should be understood that the electronic device may be disposed on either side of the tire. It should be further understood that a tire could have multiple electronic devices. For example, in one embodiment one device is disposed on each side of the tire. In another alternative embodiment, one device is disposed in a sidewall region and another device is disposed in a crown region of a tire. However, any number of devices may be located in any number of locations in the tire.

In an alternative embodiment (not shown), the bead region further includes one or more chafers that at least partially wrap around the bead and bead filler. In other words, the chafer may include a first portion disposed axially outside the bead and the bead filler, and a second portion disposed below the bead.

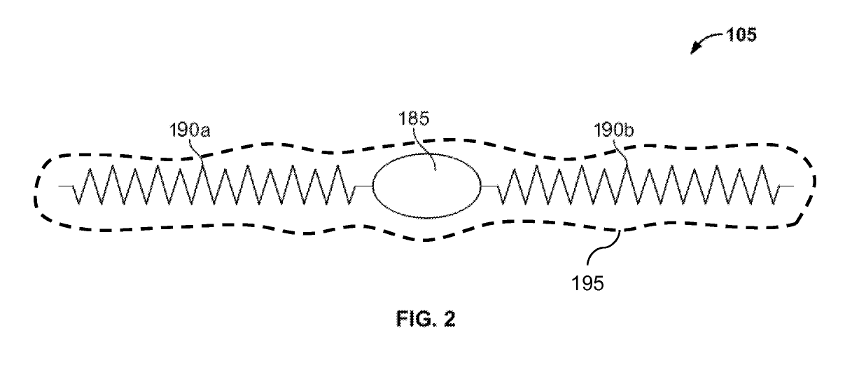

FIG. 2 is a schematic drawing of one embodiment of an electronic device 105. In the illustrated embodiment, the electronic device 105 is an RFID tag having a passive RFID transponder 185 and a pair of antennae 190a,b forming a dipole. In one embodiment, the electronic device 105 is oriented in a substantially circumferential direction. It should be understood, that the illustrated embodiment is merely exemplary, and any electronic device may be employed.

In the illustrated embodiment, the RFID tag 105 is encapsulated in an adhesive 195. In one embodiment, the adhesive 195 is a solvent-based adhesive and includes at least one of natural rubber, styrene butadiene rubber, and butadiene rubber. In such an embodiment, the solvent-based adhesive may include filler and curative dissolved in a volatile organic liquid. In an alternative embodiment, the adhesive 195 is a water-based adhesive, and includes at least one of natural rubber, styrene butadiene rubber, and butadiene rubber. In such an embodiment, the water-based adhesive may include filler and curatives suspended in an aqueous media. The adhesive may be a non-imide-based adhesive and non-acrylic.

The adhesive 195 may be a non-pressure sensitive adhesive. For example, the adhesive 195 may be a curable adhesive. Such a curable adhesive may crosslink with a layer of the tire during vulcanization of the tire.

To embed the electronic device 105 into the tire 100, a tire carcass is formed by providing the pair of bead portions 120 and the body ply 140. A portion of the body ply 140 is wrapped around each of the pair of bead portions 120. The electronic device 105 is encapsulated with an adhesive 195, such as one of the adhesives described above. The electronic device 105 is affixed to a desired location during the building of the tire carcass. A green tire is formed by providing sidewall compound 115 and a tread compound 110 on the tire carcass. The green tired is cured in a vulcanization mold.

As explained above, the electronic device may be affixed to the inner liner 180, the body ply 140, or a bead portion 120, including any of the bead portion components described above. In one embodiment, the adhesive 195 has a composition substantially similar to that of the tire layer to which the electronic device 105 is affixed. In such an embodiment, curing the green tire causes the adhesive 195 to crosslink with the tire carcass. However, as one of ordinary skill in the art would understand, the adhesive may crosslink with the tire carcass even if it has a composition that is not substantially the same as that of the tire layer to which the electronic device is affixed.

As the Examples below show, the adhesive described herein is well-suited for use in the manufacture of a tire having an embedded device.

### EXAMPLES

Peel strength measurements were performed to test the strength and durability of the solvent-based adhesives in comparison to a stock to stock control, and/or against other adhesives. In the examples below, rubber strips and adhesion pads were constructed with several rubber compositions for tire body components, such as tire sidewalls, nylon chafer skims, innerliners, treads, and belt skim. For the adhesive, a foam/sponge brush was used to apply the refresh agent in a thin, uniform layer onto the face of the adhesion pad. It was observed that not all of the adhesives coated and wetted each of the rubber surfaces well. The adhesion pads were dried at room temperature for 5 minutes when no visible wetness was apparent. The application volume of adhesives in each Example was approximately the same.

In Examples 1-13 uncured rubber strips were joined to the coated rubber on the adhesion pad. The joined rubber strips were tested by a standard procedure for 180° peel testing on an Instron 5565. These Examples were peel tested at a rate of 2 in/min and the gap distance was about 80 mm. In each case the higher force indicates the stronger bond.

In Examples 14-26, uncured rubber strips were joined to the coated, uncured rubber on the adhesion pad and the samples were cured at 170° C. for 15 minutes. The cured peel strength measurement primarily shows the strength and durability of the bond of the cured rubber components. The joined and cured rubber strips and adhesion pads were tested by a standard procedure for 180° peel testing on an Instron 5565. These Examples were peel tested at a rate of 2 in/min and the gap distance was 30 mm. In each case the higher force indicates the stronger bond.

The results of these tests are shown in the tables below.

TABLE 1
Uncured Sidewall Compound

| | | Ave | | Max | |
|---|---|---|---|---|---|
| | | Force | Uncer- | Force | Uncer- |
| Example | Adhesive | (N) | tainty | (N) | tainty |
| 1 | None | 34.4 | 3.4 | 43.5 | 4.3 |
| | (Control) | | | | |
| 2 | Solvent | 50.9 | 5.1 | 57.8 | 5.8 |
| | Based | | | | |

TABLE 2
Uncured Nylon Chafer Skim Compound

| | | Ave | | Max | |
|---|---|---|---|---|---|
| | | Force | Uncer- | Force | Uncer- |
| Example | Adhesive | (N) | tainty | (N) | tainty |
| 3 | None | 25.6 | 2.6 | 41.8 | 4.2 |
| | (Control) | | | | |
| 4 | Solvent | 58.9 | 5.9 | 89.7 | 9.0 |
| | Based | | | | |

TABLE 3
Uncured Innerliner Compound

| | | Ave | | Max | |
|---|---|---|---|---|---|
| | | Force | Uncer- | Force | Uncer- |
| Example | Adhesive | (N) | tainty | (N) | tainty |
| 5 | None | 6.6 | 0.7 | 11 | 1.1 |
| | (Control) | | | | |
| 6 | Solvent | 7.3 | 0.7 | 10.4 | 1.0 |
| | Based | | | | |

TABLE 4
Uncured Tread Compound

| | | Ave | | Max | |
|---|---|---|---|---|---|
| | | Force | Uncer- | Force | Uncer- |
| Example | Adhesive | (N) | tainty | (N) | tainty |
| 7 | None | 29.1 | 2.9 | 42.2 | 4.2 |
| | (Control) | | | | |
| 8 | Solvent | 62.0 | 6.2 | 84.3 | 8.4 |
| | Based | | | | |
| 9 | Water | 47.2 | 4.7 | 51.4 | 5.1 |
| | Based | | | | |

TABLE 5
Uncured Belt Skim Compound

| | | Ave | | Max | |
|---|---|---|---|---|---|
| | | Force | Uncer- | Force | Uncer- |
| Example | Adhesive | (N) | tainty | (N) | tainty |
| 10 | Solvent | 106.8 | 1.9 | 151.0 | 29.7 |
| | Based | | | | |
| 11 | Chemlock | 14.2 | 2.7 | 15.8 | 10.7 |
| | 6254 | | | | |
| 12 | Chemlock | 61.7 | 20.4 | 102.6 | 20.1 |
| | 6411 | | | | |
| 13 | Acrylic | 2.2 | 0.5 | 4.3 | 2.0 |

TABLE 6
Cured Sidewall Compound

| | | Ave | | Max | |
|---|---|---|---|---|---|
| | | Force | Uncer- | Force | Uncer- |
| Example | Adhesive | (N) | tainty | (N) | tainty |
| 14 | None | 572.8 | 57.3 | 1174.1 | 117.4 |
| | (Control) | | | | |
| 15 | Solvent | 831.5 | 83.1 | 1047.6 | 104.8 |
| | Based | | | | |

TABLE 7
Cured Nylon Chafer Skim Compound

| | | Ave | | Max | |
|---|---|---|---|---|---|
| | | Force | Uncer- | Force | Uncer- |
| Example | Adhesive | (N) | tainty | (N) | tainty |
| 16 | None | 569.8 | 57.0 | 1118.8 | 111.9 |
| | (Control) | | | | |
| 17 | Solvent | 675.4 | 67.5 | 1080.0 | 108.0 |
| | Based | | | | |

TABLE 8
Cured Innerliner Compound

| | | Ave | | Max | |
|---|---|---|---|---|---|
| | | Force | Uncer- | Force | Uncer- |
| Example | Adhesive | (N) | tainty | (N) | tainty |
| 18 | None | 566.7 | 56.7 | 667.6 | 66.8 |
| | (Control) | | | | |
| 19 | Solvent | 469.5 | 46.9 | 504.3 | 50.4 |
| | Based | | | | |

TABLE 9
Cured Tread Compound

| | | Ave | | Max | |
|---|---|---|---|---|---|
| | | Force | Uncer- | Force | Uncer- |
| Example | Adhesive | (N) | tainty | (N) | tainty |
| 20 | None | 384.2 | 38.4 | 585.1 | 58.5 |
| | (Control) | | | | |
| 21 | Solvent | 472.9 | 47.3 | 654.4 | 65.4 |
| | Based | | | | |
| 22 | Water | 430.9 | 43.1 | 529.1 | 52.9 |
| | Based | | | | |

TABLE 10
Cured Belt Skim Compound

| | | Ave | | Max | |
|---|---|---|---|---|---|
| | | Force | Uncer- | Force | Uncer- |
| Example | Adhesive | (N) | tainty | (N) | tainty |
| 23 | Solvent | 874.5 | 99.2 | 1613.8 | 210.3 |
| | Based | | | | |
| 24 | Chemlock | 539.1 | 3.7 | 713.5 | 26.5 |
| | 6254 | | | | |
| 25 | Chemlock | 449.8 | 79.8 | 662.2 | 181.4 |
| | 6411 | | | | |
| 26 | Acrylic | 138.8 | 149.3 | 457.0 | 426.6 |

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire comprising:
an inner liner;
a circumferential tread;
a pair of sidewalls, each sidewall including an outer rubber layer;
a pair of bead portions, each bead portion including a bead and a bead filler having an apex;
at least one body ply extending from bead to bead,
wherein at least a portion of the body ply is disposed between the inner liner and the outer rubber layer of each sidewall;
wherein the body ply includes a pair of turn up portions, each turn up portion having a turn up end axially outside of a respective bead and radially below the apex of a respective bead filler;
an electronic device disposed between the inner liner and the outer rubber layer of one of the pair of sidewalls, the electronic device having an adhesive disposed thereon, wherein the adhesive is one of a solvent-based adhesive and a water-based adhesive, and wherein the adhesive includes at least one of natural rubber, styrene butadiene rubber, and butadiene rubber.

2. The tire of claim 1, wherein the adhesive is a non-pressure sensitive adhesive.

3. The tire of claim 1, wherein the adhesive is a solvent-based adhesive including filler and curative dissolved in a volatile organic liquid.

4. The tire of claim 1, wherein the adhesive is a water-based adhesive including filler and curative suspended in an aqueous media.

5. The tire of claim 1, wherein the adhesive is a non-imide-based adhesive.

6. The tire of claim 1, further comprising a pair of chafers, each chafer at least partially wrapping around one of the pair of bead portions.

7. The tire of claim 1, further comprising a pair of abrasion portions, each abrasion portion at least partially wrapping around one of the pair of bead portions.

8. A tire comprising:
a circumferential tread;
a pair of sidewalls;
a pair of bead portions, wherein each bead portion includes a bead and a bead filler;
at least one body ply extending from bead portion to bead portion, the body ply including a pair of turn up portions radially outside of a respective bead portion; and
at least one electronic device embedded in the tire, wherein the at least one electronic device is encapsulated in a curable adhesive including at least one of natural rubber, styrene butadiene rubber, and butadiene rubber.

9. The tire of claim 8, wherein the at least one electronic device is a radio frequency identification tag.

10. The tire of claim 8, further comprising a pair of wire reinforcements, each wire reinforcement wrapping around one of the pair of bead portions.

11. The tire of claim 8, wherein the at least one electronic device includes at least a first electronic device and a second electronic device.

12. The tire of claim 8, wherein the curable adhesive is a solvent-based adhesive.

13. The tire of claim 8, wherein the curable adhesive is a water-based adhesive.

14. A method of embedding an electronic device in a tire, the method comprising:
forming a tire carcass by:
providing a pair of bead portions, each bead portion including a bead and a bead filler,
providing a body ply, and
wrapping a portion of the body ply around each of the pair of bead
portions;
providing an electronic device;
encapsulating the electronic device with an adhesive selected from the group consisting of a solvent-based adhesive and a water-based adhesive, wherein the adhesive includes at least one of natural rubber, styrene butadiene rubber, and butadiene rubber;
affixing the electronic device to the tire carcass;
forming a green tire by providing sidewall compound and a tread compound on the tire carcass; and
curing the green tire.

15. The method of claim 14, wherein the affixing the electronic device to the tire carcass include affixing the electronic device to the body ply.

16. The method of claim 14, wherein the affixing the electronic device to the tire carcass include affixing the electronic device to one of the pair of bead portions.

17. The method of claim 14, wherein the forming a tire carcass includes providing an inner liner.

18. The method of claim 17, wherein the affixing the electronic device to the tire carcass include affixing the electronic device to the inner liner.

19. The method of claim 14, wherein the adhesive is a non-acrylic adhesive.

20. The method of claim 14, wherein the curing the green tire causes the adhesive to crosslink with the tire carcass.
